(19) United States
(12) Patent Application Publication
(10) Pub. No.: US 2025/0131273 A1
(43) Pub. Date: Apr. 24, 2025

(54) Learning the Joint Distribution of Two Sequences Using Little or No Paired Data

(71) Applicant: Google LLC, Mountain View, CA (US)

(72) Inventors: Soroosh Mariooryad, Redwood City, CA (US); Sean Matthew Shannon, San Francisco, CA (US); Thomas Edward Bagby, Monte Rio, CA (US); Siyuan Ma, San Jose, CA (US); David Teh-Hwa Kao, Philadelphia, PA (US); Daisy Antonia Stanton, San Francisco, CA (US); Eric Dean Battenberg, Walnut Creek, CA (US); Russell John Wyatt Skerry-Ryan, Mountain View, CA (US)

(21) Appl. No.: 18/696,052

(22) PCT Filed: Sep. 27, 2023
(86) PCT No.: PCT/US2023/033841

§ 371 Date: Mar. 27, 2024

Related U.S. Application Data
(60) Provisional application No. 63/410,445, filed on Sep. 27, 2022.

(51) Int. Cl. G06N 3/088; G06N 3/0455

(52) U.S. Cl. CPC G06N 3/088; G06N 3/0455

(57) ABSTRACT

Provided is a noisy channel generative model of two sequences, for example text and speech, which enables uncovering the associations between the two modalities when limited paired data is available. To address the intractability of the exact model under a realistic data set-up, example aspects of the present disclosure include a variational inference approximation. To train this variational model with categorical data, a KL encoder loss approach is proposed which has connections to the wake-sleep algorithm.

### RELATED APPLICATIONS

This application claims priority to and the benefit of U.S. Provisional Patent Application No. 63/410,445, filed Sep. 27, 2022. U.S. Provisional Patent Application No. 63/410,445 is hereby incorporated by reference in its entirety.

### FIELD

The present disclosure relates generally to machine learning. More particularly, the present disclosure relates to a noisy channel generative model of two sequences, for example text and speech, which enables uncovering the associations between the two modalities when limited paired data is available.

### BACKGROUND

Learning the joint or conditional distribution of two sequences appears in many machine learning applications, e.g., automatic speech recognition (ASR), text to speech (TTS), machine translation (MT), optical character recognition (OCR), text summarization and others. Being able to learn these distributions with limited or no paired data when large amounts of unpaired data is available is desirable. Thus, the task of learning the joint or conditional distribution of two sequences is generally applicable to many seq2seq problems.

One specific setting in which this task is relevant is for text and speech for ASR and TTS models. A classical approach to speech recognition is to treat the process of generating speech audio as a noisy channel, where text is drawn from some distribution and then statistically transformed into speech audio, and the task of speech recognition is to invert this generative model to infer the text most likely to have given rise to a given speech waveform. This generative model of speech audio was historically successful but has been superseded in all modern discriminative systems by directly modeling the conditional distribution of text given speech.

The direct approach has the advantage of allowing limited modeling power to be solely devoted to the task of interest, whereas the generative approach can be extremely sensitive to faulty assumptions in the speech audio model despite the fact that this is not the primary object of interest. However the generative approach allows learning in a principled way from untranscribed speech audio, something fundamentally impossible in the direct approach. Thus, improved techniques for a generative approach to learning the joint or conditional distribution of two sequences are desired in the art.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to learn a noisy channel generative model for a first sequence domain and a second sequence domain. The method includes, for one or more generative training iterations: obtaining, by the computing system from the training dataset, an unpaired training example from the second sequence domain; processing, by the computing system, the unpaired training example from the second sequence domain with an encoder model to generate a sample from the first sequence domain; determining, by the computing system, a first likelihood that the unpaired training example from the second sequence domain is output from a decoder model when conditioned on the sample from the first sequence domain generated by the encoder model; and updating, by the computing system, one or more parameter values of the decoder model based at least in part on the first likelihood. The method includes, for one or more variational training iterations: generating, by the computing system, a sample from the second sequence domain using the decoder model when conditioned on data from the first sequence domain; determining, by the computing system, a second likelihood that the data from the first sequence domain is output by the encoder model when conditioned on the sample from the second sequence domain; and updating, by the computing system, one or more parameter values of the encoder model based at least in part on the second likelihood.

Another example aspect of the present disclosure is directed to a computer system that includes one or more processors and one or more non-transitory computer-readable media that collectively store: a noisy channel generative model of two sequences, wherein the noisy channel generative model has been learned using a variational posterior model; and instructions that, when executed by the one or more processors, cause the computer system to implement the noisy channel generative model to convert data from a second sequence domain to a first sequence domain.

Another example aspect of the present disclosure is directed to a computer system that includes one or more processors and one or more non-transitory computer-readable media that collectively store: a noisy channel generative model of two sequences, wherein the noisy channel generative model has been learned using a KL encoder loss function; and instructions that, when executed by the one or more processors, cause the computer system to implement the noisy channel generative model to convert data from a second sequence domain to a first sequence domain.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts an example generative training approach applied when an unpaired training example from a first sequence domain is retrieved from a training dataset according to example embodiments of the present disclosure.

FIG. 1B depicts an example generative training approach applied when an paired training example from both the first sequence domain and a second sequence domain is retrieved from the training dataset according to example embodiments of the present disclosure.

FIG. 1C depicts an example generative training approach applied when an unpaired training example from the second sequence domain is retrieved from the training dataset according to example embodiments of the present disclosure.

FIG. 1D depicts an example variational training approach for training an encoder model according to example embodiments of the present disclosure.

FIG. 1E depicts an example inference approach according to example embodiments of the present disclosure.

FIG. 2A depicts a block diagram of an example computing system according to example embodiments of the present disclosure.

FIG. 2B depicts a block diagram of an example computing device according to example embodiments of the present disclosure.

FIG. 2C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to a noisy channel generative model of two sequences, for example text and speech, which enables uncovering the associations between the two modalities when limited paired data is available. To address the intractability of the exact model under a realistic data set-up, example aspects of the present disclosure include a variational inference approximation. To train this variational model with categorical data, a KL encoder loss approach is proposed which has connections to the wake-sleep algorithm. Experimental results show that even tiny amount of paired data is sufficient to learn to relate the two modalities (e.g., graphemes and phonemes) when large amounts of unpaired data is available, paving the path to adopting this principled approach for ASR and TTS models in low resource data regimes.

More particularly, the present disclosure provides a noisy channel joint model of text and speech for learning from a corpus consisting of relatively large amounts of text-only data and speech-only data, but little or no parallel (text, speech) data. Example implementations cope with the sensitivity of generative modeling to faulty modeling assumptions by trying to make the generative model as accurate as possible, and cope with the resulting intractable inference problem using a variational approximate posterior of text given speech. An analogous formulation in the other direction can be adopted for text to speech models.

Similar to discrete latent variable models, when the proposed variational approach infers a discrete quantity (e.g., text or phoneme), the typical stochastic gradient variational Bayes approach is not applicable and requires a different optimization procedure. In response, the present disclosure proposed a method that can be referred to as KL encoder loss.

The large body of work on leveraging speech-only and text-only data resources to build and also to refine automatic speech recognition (ASR) and text to speech (TTS) systems rely on the close connection between the two modalities. However, the feasibility and necessary conditions to doing so is not well understood theoretically. The present disclosure formalizes the problem as identifying the joint text and speech distribution by only observing its marginal samples and provides solutions to this problem.

Thus, one aspect of the present disclosure is directed to a noisy channel joint model of text and speech distribution. Specifically, the noisy channel joint model can be developed through the use of a variational noisy channel model or encoder. Another aspect of the present disclosure is directed to a KL encoder loss to train the discrete latent variable models.

The systems and methods of the present disclosure provide a number of technical effects. As one example, the proposed approaches enable improved learning of joint distributions even in settings with little to no paired training data. This enables application of the proposed techniques to many domains that previously were not explored using joint probabilities due to the lack of paired training data for such domains. In addition, because generation (e.g., labeling) of paired training data consumes resources such as computational resources, the proposed approaches reduce the computational cost of learning of joint distributions. As another example technical effect and benefit, the proposed approaches enable the more principled generative approach to be extended to additional domains (e.g., as opposed to discriminative approaches).

With reference now to the Figures, example embodiments of the present disclosure will be discussed in further detail.

### Example Training and Inference Approaches

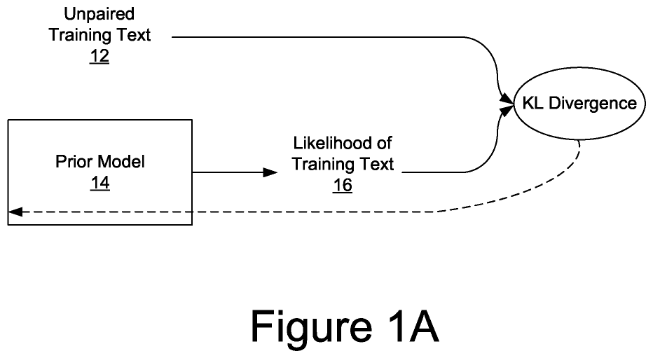

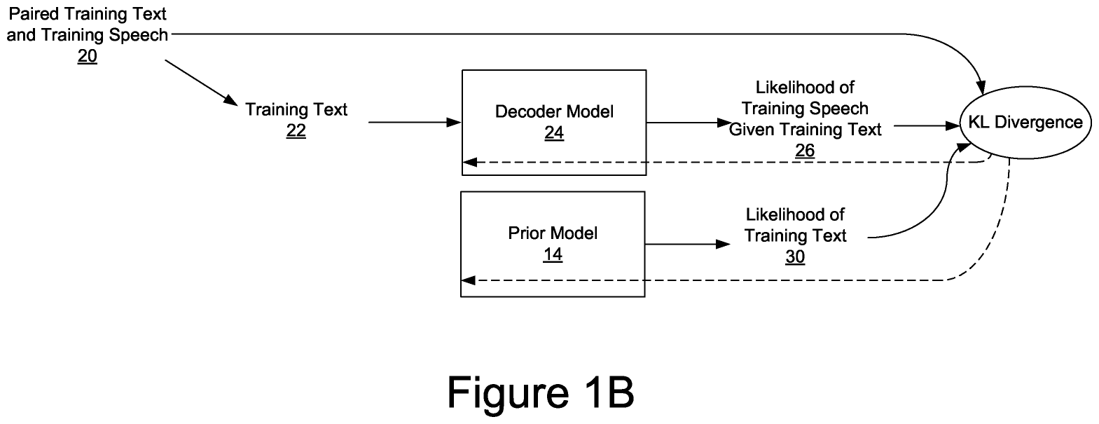

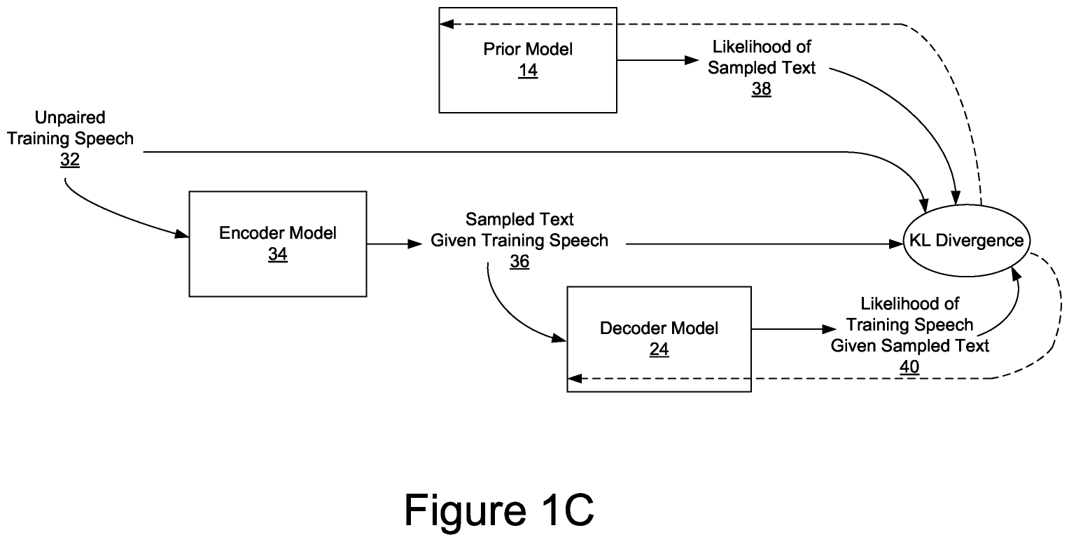

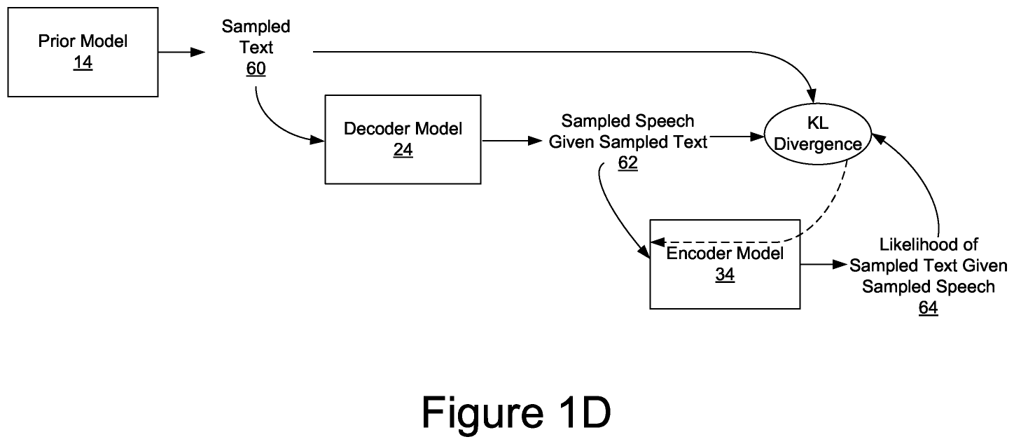

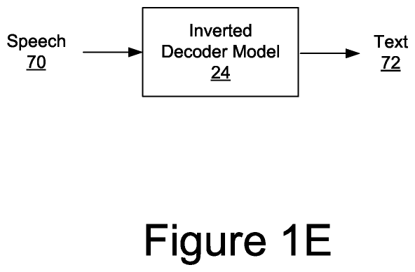

FIGS. 1A-D show example approaches to learn a noisy channel generative model for a first sequence domain and a second sequence domain according to example aspects of the present disclosure. For ease of explication and to provide one example, in FIGS. 1A-D the first sequence domain comprises textual sequences and the second sequence domain comprises sequences of speech data. For example, the speech data can be expressed as a raw waveform or using Mel spectrograms. However, this is provided as one example application only. In another example the second sequence domain comprises textual sequences and the first sequence domain comprises sequences of speech data. In another example, the first sequence domain comprises textual sequences and the second sequence domain comprises sequences of image data corresponding to rendered characters. In another example, the first sequence domain comprises sequences expressed in a first language (e.g., English) and the second sequence domain comprises sequences expressed in a second language (e.g., French). Other sequential domains are possible as well such as genetic sequences, protein sequences, sequences of sensor data, and/or other forms of sequential data.

FIG. 1A depicts an example generative training approach applied when an unpaired training example from a first sequence domain is retrieved from a training dataset according to example embodiments of the present disclosure. As illustrated in FIG. 1A, a computing system obtains, from a training dataset, an unpaired training example 12 from the first sequence domain. The computing system determines a likelihood 16 that the unpaired training example 12 from the first sequence domain is output from a prior model 14. The computing system updates one or more parameter values of the prior model 14 based at least in part on the likelihood 16.

FIG. 1B depicts an example generative training approach applied when an paired training example from both the first sequence domain and a second sequence domain is retrieved from the training dataset according to example embodiments of the present disclosure. As illustrated in FIG. 1B, a computing system obtains, from the training dataset, a paired training example 20 comprising paired training data from the first sequence domain 22 and paired training data from the second sequence domain. The computing system determines a likelihood 30 that the paired training data from the first sequence domain is output from the prior model 14 and updates one or more parameter values of the prior model 14 based at least in part on the likelihood 30. The computing system also determines an additional likelihood 26 that the paired training data from the second sequence domain is output from a decoder model 24 when conditioned on the paired training data from the first sequence domain 22. The computing system updates one or more parameter values of the decoder model 24 based at least in part on the additional likelihood 26.

FIG. 1C depicts an example generative training approach applied when an unpaired training example from the second sequence domain is retrieved from the training dataset according to example embodiments of the present disclosure. As illustrated in FIG. 1C, a computing system obtains, from the training dataset, an unpaired training example from the second sequence domain 32. The computing system processes the unpaired training example from the second sequence domain 32 with an encoder model 34 to generate a sample from the first sequence domain 36. The computing system determines a likelihood 40 that the unpaired training example from the second sequence domain 32 is output from a decoder model 24 when conditioned on the sample from the first sequence domain 36 generated by the encoder model 34. The computing system updates one or more parameter values of the decoder model 24 based at least in part on the likelihood 40.

In some implementations, the computing system can additionally determine a likelihood 38 that the sample from the first sequence domain 36 is output by the prior model 14 and can update one or more parameters of the prior model 14 based on the likelihood 38.

FIG. 1D depicts an example variational training approach for training an encoder model according to example embodiments of the present disclosure. As illustrated in FIG. 1D, a computing system generates a sample from the second sequence domain 62 using the decoder model 24 when conditioned on data from the first sequence domain 60. The computing system determines a likelihood 64 that the data from the first sequence domain 60 is output by the encoder model 34 when conditioned on the sample from the second sequence domain 62. The computing system updates one or more parameter values of the encoder model 34 based at least in part on the likelihood 64.

As one example, as illustrated in FIG. 1D, the data from the first sequence domain 60 can be or include a sample from the first sequence domain generated by the prior model 14.

FIG. 1E depicts an example inference approach according to example embodiments of the present disclosure. As illustrated in FIG. 1E, a computing system can invert the decoder model 24 to generate data from the first sequential domain (e.g., text 72) when provided with data from the second sequential domain (e.g., speech data 70).

### Example Models

This section describes an example proposed joint model of two sequences and how to train it. The two sequences x=[xₛ]ₛ₌₀^{S-1} and y=[yₜ]ₜ₌₀^{T-1} may be different lengths (S≠T) and may each have discrete or continuous values. For example, the first sequence x might be text consisting of a sequence of graphemes and the second sequence y a sequence of mel spectrogram frames in an application related to speech recognition and synthesis, or x might be text and y a sequence of image patches corresponding to printed characters in an application related to optical character recognition.

Some example implementations assume that there is a mix of paired and unpaired data. Specifically some example implementations assume the corpus is generated by repeatedly and independently sampling a sequence pair (x, y) from the true distribution (or data distribution) p_{T}(x, y) and then keeping only x with probability α, only y with probability β, or both x and y with probability γ, where α+β+γ=1. Some example implementations refer to γ as the paired fraction. Some example implementations are applied in the regime γ<<1, including the extreme case γ=0 where there is no paired data.

One advantage of generative modeling is that it provides a principled way to use unpaired data during parameter estimation. The model p_{λ}(x, y) defines a joint distribution over the two sequences x and y with parameters, which in turn defines marginals p_{λ}(x) and p_{λ}(y). If the marginals are tractable then some example implementations may estimate λ by minimizing the cross-entropy

$$- {\sum }_{u} {p}_{T} ( u ) log {p}_{λ} ( u ) \qquad ( 1 )$$

where u is “whatever is observed” for a given example, be that x or y or (x, y). In practice the expectation over p_{T}(u) is replaced with samples from the training corpus yielding a form of maximum likelihood estimation. Equation (1) can be written concisely as the KL divergence KL(p_{T}(u)∥p_{λ}(u)) with the understanding that the unknown but irrelevant additive constant Σᵤ p_{T}(u) log p_{T}(u) is not computed in practice. This KL divergence can in turn be written as

$$K L ( {p}_{T} ( u ) ‖ {p}_{λ} ( u ) ) = α KL ( {p}_{T} ( x ) ‖ {p}_{λ} ( x ) ) \qquad ( 2 )$$

$$+ β KL ( {p}_{T} ( y ) ‖ {p}_{λ} ( y ) )$$

$$+ γ KL ( {p}_{T} ( x , y ) ‖ {p}_{λ} ( x , y ) )$$

This loss incentivizes the model to match both the marginal and joint distributions of the data.

The generative model used in some example implementations is a form of noisy channel model. Some example implementations factorize p_{λ}(x, y) in terms of a prior p_{λ}(x) and decoder p_{λ}(y|x). Some example implementations can use recurrent autoregressive models with step-by-step end-of-sequence decisions for both the prior and decoder, using attention to incorporate the conditioning information x for the decoder. The noisy channel model allows directly computing p_{λ}(x) and p_{λ}(x, y). The marginal p_{λ}(y) is tractable for simple models such as a Markovian prior and decoder. When the marginal is not tractable, some example implementations introduce a variational posterior (or encoder) qᵥ(x|y) and replace KL(p_{T}(y) ∥p_{λ}(y)) in (2) with the upper bound

$$K L ( {p}_{T} ( y ) {q}_{v} ( x \vert y ) ‖ {p}_{λ} ( x , y ) ) \qquad ( 3 )$$

This is the conventional negative evidence lower bound objective (ELBO) up to a constant. In contrast to variational latent variable models such as variational autoencoders (VAEs), here the space modeled by the prior and variational posterior is grounded by observed data. In the example case in which x is text and y is speech, p_{λ}(y|x) is a TTS model and qᵥ(x|y) is an ASR model.

### Example KL Encoder Loss

To cope with discrete-valued x, some example implementations can perform a novel variant of the wake-sleep algorithm. This section describes this approach.

First, this section reviews why discrete x is more challenging than continuous x. The expression (3) involves an expectation over qᵥ(x|y). If x is a sequence of continuous values of known length then this expectation can be reparameterized, allowing low variance finite sample approximations to the gradient of this term with respect to v. However if x is discrete this is not possible. There have been many alternative methods proposed to compute finite sample approximations to the gradient, including REINFORCE, RELAX, and many others. In an example proposed application, this challenge applies even if x has continuous values, since the length of x is unknown and discrete.

Some example implementations solve this problem by modifying the loss used to train the variational posterior. Instead of minimizing KL(p_{T}(y) qᵥ(x|y)∥p_{λ}(x, y)) with respect to the encoder parameters v, some example implementations instead minimize KL(p_{λ}(x, y)∥p_{T}(y) qᵥ(x|y)) with respect to v. Some example implementations continue to train the generative model parameters λ as before. This training procedure is similar to the wake-sleep algorithm, where the λ updates and v updates correspond to the wake phase and sleep phase respectively. This approach can be referred to as KL encoder loss training since the variational posterior appears in the right “KL” argument to the KL divergence, as opposed to the conventional ELBO for which the variational posterior appears in the left “reverse KL” argument to the KL divergence. The conventional ELBO and KL encoder loss have the same non-parametric optimal variational posterior, namely \hat{q}(x|y)=p_{λ}(x|y). The two approaches place different computational demands on qᵥ and p_{λ}. The conventional approach requires tractable reparameterized samples and log prob computations for qᵥ(x|y) and tractable log prob computations for p_{λ}(x, y). The KL encoder loss approach requires tractable log prob computations for qᵥ(x|y) and tractable samples for p_{λ}(x, y).

The use of different objectives for different parts of the model is reminiscent of GAN training, but note that here the losses are cooperative rather than adversarial, in the sense that making the variational posterior optimal improves both the variational loss and the generative loss, whereas making the critic optimal in classic GAN training makes the generator loss worse. Nevertheless, there is no guarantee that the training dynamics of the (generative, variational) system are convergent in general.

If the learning rate used for the generative parameters λ is set sufficiently small relative to the learning rate used for the variational parameters v, and the variational posterior is sufficiently flexible, then the variational posterior is able to remain essentially optimal throughout training and so the training dynamics are effectively just gradient descent on (2) with respect to λ, which has well-behaved training dynamics

### Example Model Training

This section now summarizes an example proposed training procedure. The loss l^{gen} used to learn the parameters λ of the generative model p_{λ}(x, y)=p_{λ}(x) p_{λ}(y|x) and loss l^{var} used to learn the parameters v of the variational posterior qᵥ(x|y) are

$${l}_{λ ; v}^{g e n} = - α {\sum }_{x} {p}_{T} ( x ) log {p}_{λ} ( x ) \qquad ( 4 )$$

$$- β {\sum }_{x , y} {p}_{T} ( y ) {q}_{v} ( x \vert y ) [ log {p}_{λ} ( x , y ) - log {q}_{v} ( x \vert y ) ]$$

$$- γ {\sum }_{x , y} {p}_{T} ( x , y ) log {p}_{λ} ( x , y )$$

$${l}_{v ; λ}^{var} = - {\sum }_{x , y} {p}_{λ} ( x , y ) log {q}_{v} ( x \vert y ) \qquad ( 5 )$$

In practice each loss can be approximated with a stochastic minibatch approximation based on the training corpus in the natural way, using the a term for examples where only x is observed, the β term for examples where only y is observed, and the y term for examples where both x and y are observed. Some example implementations perform simultaneous gradient descent on (1, v) based on the gradients (∂l_{λ;v}^{gen}/∂χ, ∂l_{v;λ}^{var}/∂v).

Some example implementations perform some or all of the following variations for training. Firstly, samples from autoregressive models can suffer from small errors compounding over time, particularly when trained with maximum likelihood estimation/KL. This only weakly penalizes unrealistic next-step samples because KL is a “covering” rather than “mode-seeking” divergence. Another approach is to adjust the temperature of the distribution. The prior, decoder and variational posterior are all trained with KL, and some example implementations apply temperature adjustment when sampling from these models during both training and decoding. For example, for the variational posterior some example implementations recursively sample from

$$\frac{1}{{Z}_{v} ( {x}_{0 : t - 1} , y )} {( {q}_{v} ( {x}_{t} \vert {x}_{0 : t - 1} , y ) )}^{\frac{1}{T}}$$

instead of qᵥ(xₜ|x_{0:t-1}, y). Typically T=0.5.

Secondly, at random initialization the generative model and variational posterior are both very suboptimal, and the noisy gradients from the β term of l^{gen} may swamp the small but consistent signal from the paired data y term when training the decoder. To alleviate this, some example implementations pre-train with the β term omitted from l^{gen}, effectively ignoring the y-only data.

Finally, some example implementations optionally ignore the ELBO term throughout training when updating the prior p_{λ}(x). In the regime where a is small this could prevent the model learning important information about p_{T}(x) present in the y-only data, but in the regime considered here where there is plenty of x-only data, it slightly helps to stabilize training.

### Example Identifiability Discussion

This section discusses the challenges that exist when little or no paired data is available. The discussion mainly focuses on the case of no paired data.

First, define identifiability given no paired data: say a generative model p_{λ}(x, y) is identifiable given no paired data if matching the marginals implies matching the joint, that is if p_{λ}(x)=p_{λ}_{_{T}}(x) for all sequences x and p_{λ}(y)=p_{λ}_{_{T}}(y) for all sequences y implies p_{λ}(x, y)=p_{λ}_{_{T}}(x, y) for all sequences x and y. Some example implementations do not require λ=λ_{T}. It may be thought of as follows: λ_{T} as the true parameters and A as the model parameters being learned.

Even in the case where the model is identifiable, local optima may be a substantial impediment to learning. These local optima are quite a generic feature of learning from little or no paired data. For example, if α=γ=0 in (2) then x becomes a latent variable, and so the loss is invariant under permutations of the categories or dimensions used for x. This symmetry over permutations means that it is impossible even in principle to recover the true mapping between x and y. Since (2) is continuous in (α, β, γ), small α and γ values will have multiple spurious local optima as the remnants of the spurious global optima which exist at α=γ=0.

This section now discusses the need to restrict the power of the decoder. If the decoder p_{λ}(y|x) is very flexible then it may be possible for it to completely ignore x yet still obtain a perfect marginal p_{λ}(y)=p_{T}(y). Clearly this learns nothing about the true mapping between x and y. Some example implementations therefore restrict the power of the decoder so that it is forced to use x. In contrast some example implementations try to make the prior and variational posterior as flexible as possible in order to ensure accurate modeling and as tight a variational bound as possible.

### Example Time Locality

One widely applicable way to limit decoder power is by assuming time locality. It can be said that a decoder has strict time locality if the overall probability can be written as a product of time-local factors

$${p}_{λ} ( y \vert x ) = {\prod }_{t = 0}^{T - 1} {f}_{t} ( {y}_{t - L : t + L} , {x}_{\overline{s} ( t ) - K : \overline{s} ( t ) + K} ) \qquad ( 6 )$$

where time constants K, L∈ [symbol] _{≥0} and s̅: {0, . . . , T−1}→{0, . . . , S−1} is a function aligning each position in y to a position in x. For example, the decoder p_{λ}(y|x)=Πₜ p_{λ}(yₜ|x_{s̅(t)}) which is independent over time and for which each yₜ only depends on a single xₛ is strictly time local with K=L=0. Some example implementations refer to a decoder as time local if (6) holds approximately. If it is assumed that the true marginal p_{T}(y) has long-range correlations which mean it is either not time local, or is time local with time constant much greater than L, then the way for the model as a whole to capture these correlations across time in its marginal p_{λ}(y) is to induce them from corresponding correlations across time in x. This provides the generative model with an incentive to uncover how x maps to y.

Time locality is an intuitively reasonable assumption in many seq2seq problems such as speech recognition and synthesis, optical character recognition and machine translation (with non-monotonic s̅). It thus forms a promising middle ground as a weak enough assumption to have wide applicability but a strong enough assumption to potentially support learning the joint with little or no paired data.

### A Worked Example of Identifiability

To help guide an example proposed intuition surrounding identifiability in more complicated cases, this section now examines identifiability in the case of a Markovian prior and time-independent and time-synchronous decoder with no paired data available. In this case p_{λ}(x, y)=Πₜ p_{λ}(xₜ|xₜ₋₁)p_{T}(yₜ|xₜ). Let Bᵢⱼ=p_{λ}(x₀=i, x₁=j), Oᵢₚ=p_{λ}(yₜ=p|xₜ=i), D_{pq}=p_{λ}(y₀=p, y₁=q) and 1 be a vector of ones. It can be assumed that the prior is a stationary distribution, that is B1=B^{T}1=b and that bᵢ>0 for all i. The prior can be learned from unpaired data, and so some example implementations assume p_{T}(x₀=i, x₁=j)=Bᵢⱼ. Let C_{pq}=p_{T}(y₀=p,y₁=q) and c=C1=C^{T}1. In this case one can conveniently express the relationship between the y marginals and x marginals as a matrix multiplication D=O^{T}BO.

First consider the case where O is a permutation matrix, corresponding to a substitution cipher. Assume x is English text represented as a series of graphemes. For example, the ciphertext y might be wi jtvwjpvwjbhjwi jgvw, corresponding to some English plaintext x. It is known that this simple cipher can be broken by frequency analysis, by tabulating the frequency of grapheme n-grams in the ciphertext and looking for grapheme n-grams with similar frequencies in conventional English text. Some example implementations may codify this by considering the singular value decompositions of B and C. As long as the singular values of B are distinct and non-zero then we can completely recover O and have identifiability given no paired data. The plaintext above is the cat sat on the mat.

Secondly consider the case where O is not restricted to be a permutation matrix but where the x and y alphabets both have size two, say xₛ, yₜ ∈{0,1}. Since O1=1, there are only two degrees of freedom in O, say

$$O = [ \begin{matrix}η & 1 & - η \\ ζ & 1 & - ζ\end{matrix} ] \qquad ( 7 )$$

First consider cases where we do not have identifiability, which may be particularly helpful for building general intuition. The first degenerate case is where B is low rank, that is B=bb^{T} and x₀ and x₁ are independent. In this case O is never identifiable, since any (η, ζ) on the line ηb₀+ζb₁=c₀ results in the same unigram marginal p_{λ}(y₀) and so the same overall marginal p_{λ}(y) due to independence over time. This is a simple example of needing correlations over time in x that are longer than the decoder can model on its own in order to have identifiability. The second degenerate case that can be considered is where

$${b}_{0} = \frac{1}{2} .$$

In this case

$$B = [ \begin{matrix}{B}_{00} & {B}_{01} \\ {B}_{01} & {B}_{00}\end{matrix} ] \qquad ( 8 )$$

This obeys the symmetry that swapping 0s and 1s does not change the probability of a sequence under the prior. Intuitively this means there is no way to distinguish which x symbol maps to a given y symbol, just like in the case where x is a latent variable which is never observed. Formally (η, ζ) and (ζ, η) result in the same marginal p_{λ}(y) for all y. Technically we do still have identifiability if η=ζ, but this case is practically uninteresting because it means x and y are completely independent. Otherwise we do not have identifiability when

$${b}_{0} = \frac{1}{2} .$$

By considering sequences of length two and three, if B is full rank and

$${b}_{0} \neq \frac{1}{2}$$

then we do have identifiability given no paired data. The general pattern in this simple case is that the time locality assumption is sufficient to ensure identifiability unless the marginal p_{λ}(x) obeys one of a finite list of a specific symmetries that make identification impossible.

### Example Devices and Systems

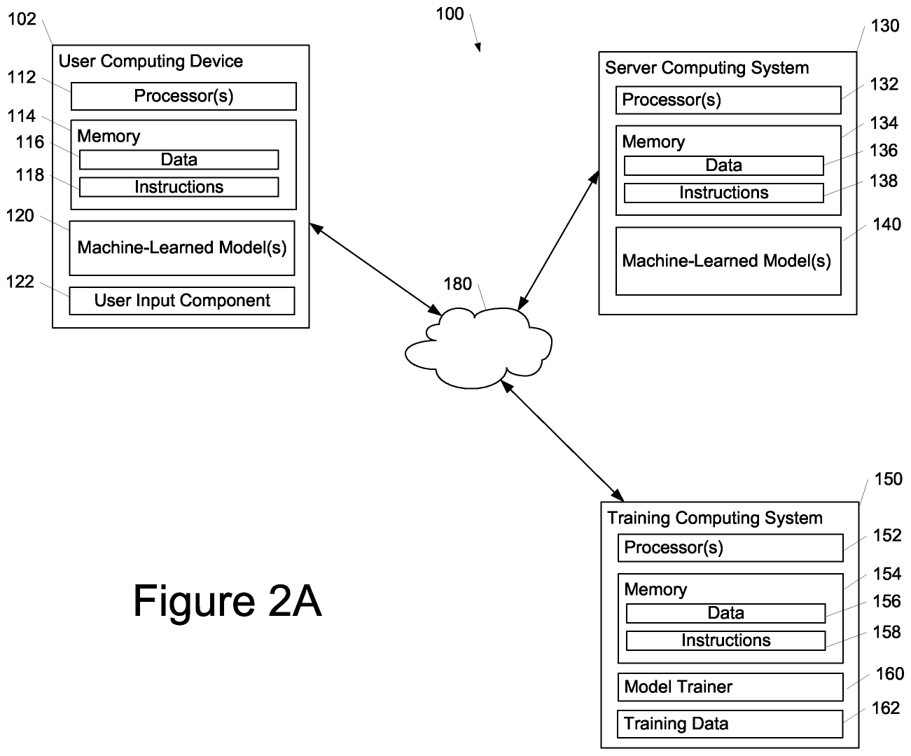

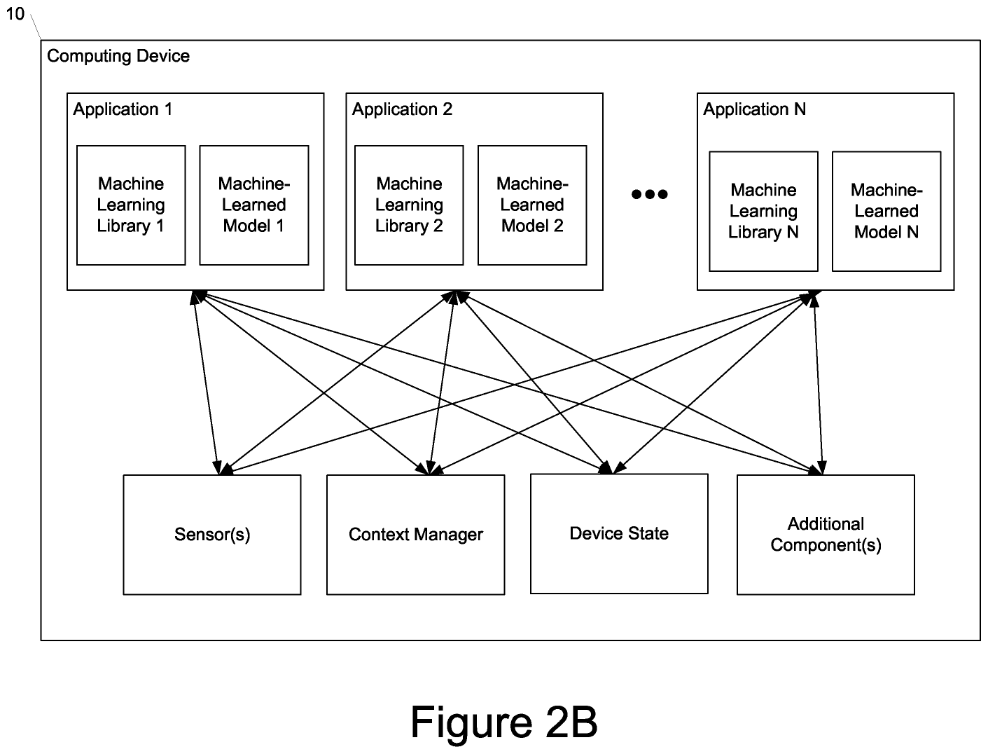

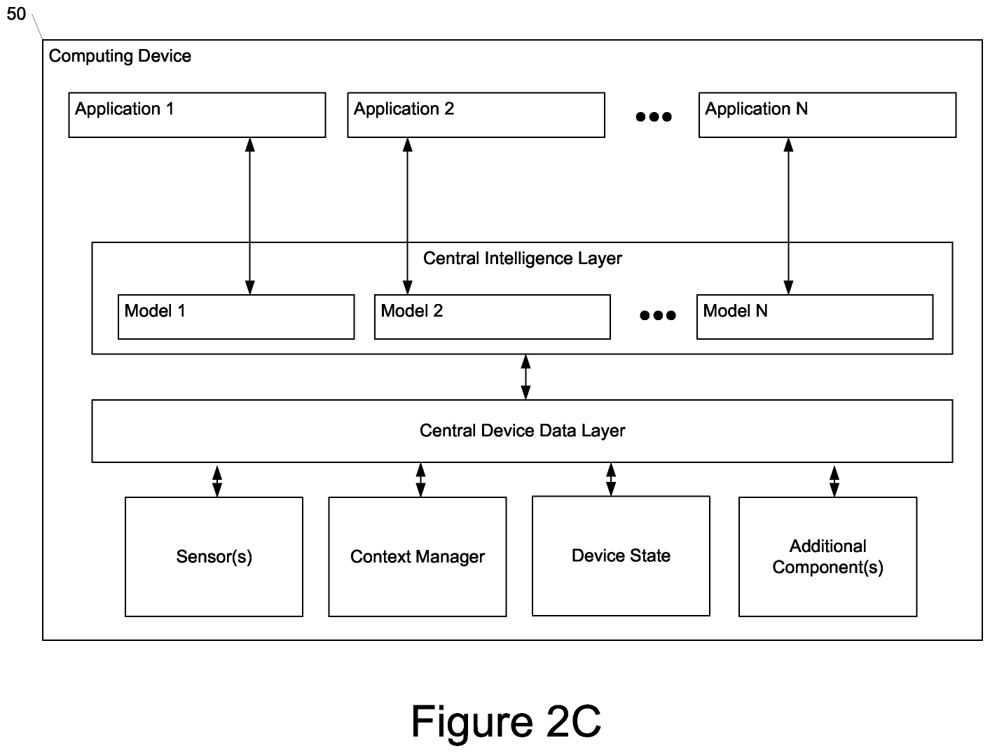

FIG. 2A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1A-E.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel conversion across multiple instances of sequential data).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1A-E.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, unpaired training examples from a first sequence domain, unpaired training examples from a second sequence domain, and paired training examples from both the first sequence domain and the second sequence domain. In some implementations, there may be a very small number of paired training examples relative to the number of unpaired training examples.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 2A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 2B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to learn a noisy channel generative model for a first sequence domain and a second sequence domain, the method comprising:
for one or more generative training iterations:
obtaining, by the computing system from the training dataset, an unpaired training example from the second sequence domain;
processing, by the computing system, the unpaired training example from the second sequence domain with an encoder model to generate a sample from the first sequence domain;
determining, by the computing system, a first likelihood that the unpaired training example from the second sequence domain is output from a decoder model when conditioned on the sample from the first sequence domain generated by the encoder model; and
updating, by the computing system, one or more parameter values of the decoder model based at least in part on the first likelihood; and
for one or more variational training iterations:
generating, by the computing system, a sample from the second sequence domain using the decoder model when conditioned on data from the first sequence domain;
determining, by the computing system, a second likelihood that the data from the first sequence domain is output by the encoder model when conditioned on the sample from the second sequence domain; and
updating, by the computing system, one or more parameter values of the encoder model based at least in part on the second likelihood.

2. The computer-implemented method of claim 1, wherein the first sequence domain comprises textual sequences and the second sequence domain comprises sequences of speech data.

3. The computer-implemented method of claim 1, wherein the second sequence domain comprises textual sequences and the first sequence domain comprises sequences of speech data.

4. The computer-implemented method of claim 1, wherein the first sequence domain comprises textual sequences and the second sequence domain comprises sequences of image data corresponding to rendered characters.

5. The computer-implemented method of claim 1, wherein the first sequence domain comprises sequences expressed in a first language and the second sequence domain comprises sequences expressed in a second language.

6. The computer-implemented method of claim 1, wherein the data from the first sequence domain comprises a sample from the first sequence domain generated by a prior model.

7. The computer-implemented method of claim 6, further comprising, for one or more of the generative training iterations:
obtaining, by the computing system from the training dataset, an unpaired training example from the first sequence domain;
determining, by the computing system, a third likelihood that the unpaired training example from the first sequence domain is output from the prior model; and
updating, by the computing system, one or more parameter values of the prior model based at least in part on the third likelihood.

8. The computer-implemented method of claim 1, further comprising, for one or more of the generative training iterations:
obtaining, by the computing system from the training dataset, a paired training example comprising paired training data from the first sequence domain and paired training data from the second sequence domain;
determining, by the computing system, a fourth likelihood that the paired training data from the first sequence domain is output from the prior model;
updating, by the computing system, one or more parameter values of the prior model based at least in part on the fourth likelihood;
determining, by the computing system, a fifth likelihood that the paired training data from the second sequence domain is output from the decoder model when conditioned on the paired training data from the first sequence domain; and
updating, by the computing system, one or more parameter values of the decoder model based at least in part on the fifth likelihood.

9. The computer-implemented method of claim 1, wherein the decoder model is expressed as a product of time-local factors.

10. The computer-implemented method of claim 1, further comprising:
inverting, by the computing system, the decoder model to generate data from the first sequential domain when provided with data from the second sequential domain.

11. The computer-implemented method of claim 1, wherein one or both of the encoder model and decoder model comprise autoregressive recurrent neural networks.

12. A computer system, comprising:
one or more processors; and
one or more non-transitory computer-readable media that collectively store:
a noisy channel generative model of two sequences, wherein the noisy channel generative model has been learned using a variational posterior model; and
instructions that, when executed by the one or more processors, cause the computer system to implement the noisy channel generative model to convert data from a second sequence domain to a first sequence domain.

13. The computer system of claim 12, wherein the variational posterior model has been trained with a KL encoder loss function.

14. The computer system of claim 13, wherein the KL encoder loss comprises a KL divergence to a generative distribution of the noisy channel generative model.

15. A computer system, comprising:
one or more processors; and
one or more non-transitory computer-readable media that collectively store:
a noisy channel generative model of two sequences, wherein the noisy channel generative model has been learned using a KL encoder loss function; and
instructions that, when executed by the one or more processors, cause the computer system to implement the noisy channel generative model to convert data from a second sequence domain to a first sequence domain.

16. The computer system of claim 15, wherein the KL encoder loss comprises a KL divergence to a generative distribution of the noisy channel generative model.
